(19) United States
(12) Patent Application Publication
(10) Pub. No.: US 2009/0212583 A1
(43) Pub. Date: Aug. 27, 2009

(54) ELEVATED LOCKING TONGS

(76) Inventor: Matthew Frank, Seattle, WA (US)

Correspondence Address: CLOUTIER & ENGLE, PLLC;ATTN: PRIYA SINHA CLOUTIER, 320 DAYTON STREET, SUITE 260, EDMONDS, WA, 98020, US

(21) Appl. No.: 12/037,668

(22) Filed: Feb. 26, 2008

(51) Int. Cl. B25B 9/02

(52) U.S. Cl. 294/99.2

(57) ABSTRACT

The object of the Kitchen Tongs With Integrated Elevating Feet is to provide an easy to use locking system which allows the user to lock the tong in the closed position. Additionally, the tongs are supported so that when they are placed on a horizontal surface the end used for grasping food or other items is raised above the horizontal surface on which they are placed.

### CROSS-REFERENCES TO RELATED APPLICATIONS

Not Applicable

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### BRIEF SUMMARY OF THE INVENTION

Tongs are well known in kitchens around the world. Tongs are generally used to lift food or other items that should not or cannot be touched because of temperature, hygiene or any number of other reasons. However, if left in an open position, tongs are difficult to store because they can take up a great deal of space in a drawer or cabinet.

Furthermore, the user of the tongs may need to temporarily place the tongs down while handling another matter. This is problematic because the tongs will revert to the open position once the user releases his grip. Once placed on a horizontal surface, tongs in an open position are more difficult to quickly pick up and have ready for use.

Once set on a horizontal surface, the end of the tongs used to grasp food or other items will touch the horizontal surface. This is problematic because the tongs will dirty the horizontal space and/or the horizontal space will dirty the tongs raising concerns about hygiene.

Information relevant to attempts to address these problems can be found in: Yamanaka, US 2007/0130034 (June 2007); McRorie, US 2006/0157996 (July 2006); Kerr, US 2005/0253404 (November 2005); Sumter, US 2004/0239129 (December 2004); and Oretti, U.S. Pat. No. 4,728,139 (March 1988). However, each of these references suffers from one or more of the following disadvantages:
1) does not provide a locking system that allows the user to easily place the tongs in the open or closed position;
2) does not provide a means to rest the tongs on a horizontal surface such that the end used for grasping food or other items is raised above the horizontal surface.

The object of the Elevated Lockable Tongs (“Tongs”) is to provide an easy to use locking system which allows the user to lock the Tongs in the closed position. Additionally, the Tongs are supported so that when they are placed on a horizontal surface, the grasping end is raised above the horizontal surface.

### BRIEF SUMMARY OF THE INVENTION

The current invention provides the user with a pair of tongs that have a locking mechanism so that the tongs can be placed in a closed position without addition of continued pressure from the user on the hinged end and a support so that when the tongs are placed on a horizontal surface the grasping end is raised above the horizontal surface.

### BRIEF DESCRIPTION OF THE SEVERAL VIEWS OF THE DRAWINGS

Other features and advantages of the present invention will become apparent in the following detailed descriptions of the preferred embodiment with reference to the accompanying drawings, of which:

FIG. 1 is an elevation view of the Tongs;

FIG. 2 is an exploded view of the Tongs' locking system in a closed position;

FIG. 3 is an exploded view of the Tongs' locking system in an open position;

FIG. 4 is an exploded view of the Tongs' grasping end.

### DETAILED DESCRIPTION OF THE INVENTION

While preferred embodiments of the invention will be shown and described, it will be obvious to those skilled in the art that changes and modification may be made therein without departing from the invention in its broader aspects.

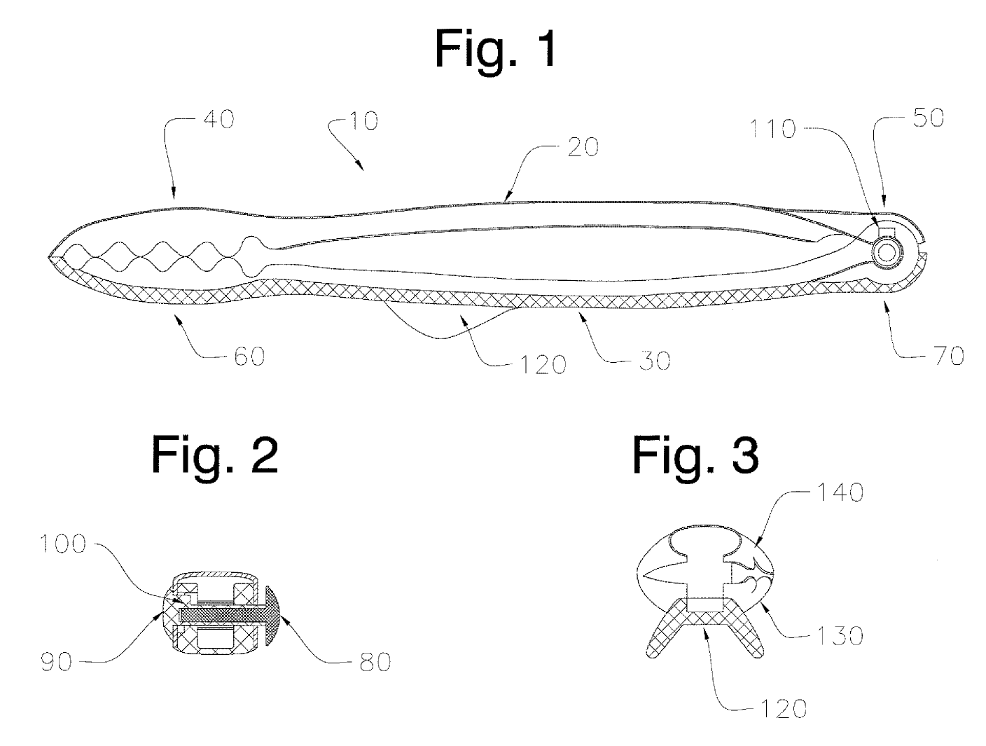

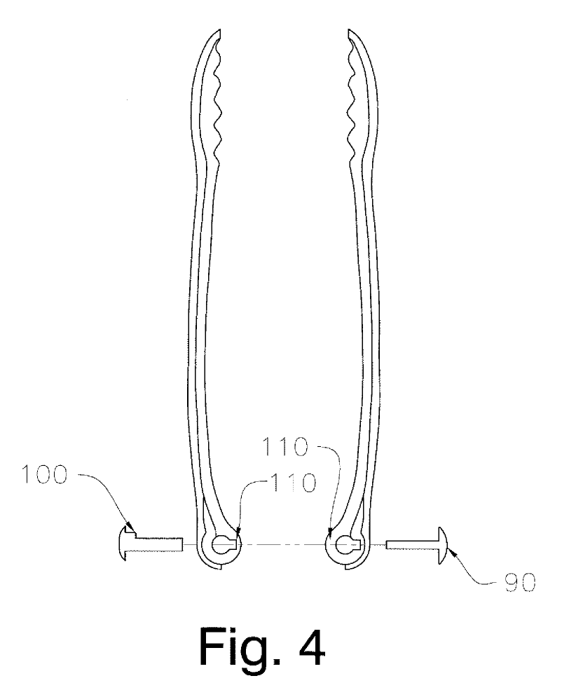

Referring to FIGS. 1 through 3, the Tongs 10 are comprised of a first member 20 and a second member 30. The first member 20 has a grasping end 40 and a hinge end 50. The second member 30 has a grasping end 60 and a hinge end 70. Either the first member 20 or the second member 30 comprises a support 120 along said member so that when the Tongs are placed on a horizontal surface the gripping end is raised above the horizontal surface.

The hinge end 50 of the first member 20 and the hinge end 70 of the second member 30 are pivotally connected allowing first member 20 and second member 30 to move apart from each other (open position) or move close to each other (closed position).

The Tongs has a means to lock it in the closed position. In the preferred embodiment, the pivotal connection comprises a two piece hinge 80, 90. Parts 80 and 90 are connected by axial threads, with piece 90 having female threads and piece 80 having male threads. This two piece hinge 80, 90 also has a keyed section 100 [as an integral part of piece 90.

To lock the Tongs in the closed position, the Tongs are placed in the closed position, which aligns keyways 110 in the hinge ends 50, 70 of the two members 20, 30, and the pivotal connection is pushed from [the piece 90 end of the two piece hinge 80,90 to insert the keyed section 100 into the keyway 110.

To unlock the tongs, the pivotal connection is pushed from the piece 80 end of the two piece hinge 80,90 to push the keyed section 100 out of the keyway 110. FIG. 2A is exploded views of the locking mechanism.

In the preferred embodiment the grasping ends 40, 60 are shaped like a spoon. Also, in the preferred embodiment, a portion of the spoon shaped grasping ends 40, 60 is scalloped 130, 140.

What is claimed:

1. A pair of tongs, comprising:
a first member having a grasping end and a hinge end;
a second member having a grasping end and a hinge end;
a means to pivotally connect said first member and said second member at their hinge ends allowing pivotal movement between a open position and a closed position;
a support, where the support is located on said first member, which elevates said grasping ends when the tongs are placed on a horizontal surface; said support comprises at least a first arm and a second arm;
said first arm has a first attached end and a first free end; said first attached end is attached to said first member;
said second arm has a second attached end an a second free end; said second attached end is attached to said first member;
the distance between the first free end and the second free end being greater than the distance between the first attached end and the second attached end.

2. The tongs of claim 1 further comprising a means to lock the tongs in the closed position.

3. The means to lock of claim 2 comprises keyways in the hinge ends of the first and second members, and a keyed section on one end of said pivotally connecting means.
